(19) United States
(12) Patent Application Publication
(10) Pub. No.: US 2019/0210574 A1
(43) Pub. Date: Jul. 11, 2019

(54) Outrigger Stabilizer Pad Having a Frictional Surface

(71) Applicant: Bigfoot Construction Equipment, Inc., Woodstock, IL (US)

(72) Inventor: Jefferson Steiner, Woodstock, IL (US)

(21) Appl. No.: 16/238,588

(22) Filed: Jan. 3, 2019

Related U.S. Application Data
(60) Provisional application No. 62/615,626, filed on Jan. 10, 2018.

(51) Int. Cl. B60S 9/02; B66C 23/78; E02F 9/08

(52) U.S. Cl. CPC B60S 9/02; E02F 9/085; B66C 23/78

(57) ABSTRACT

The present disclosure relates to outrigger pads, and specifically outrigger stabilizer pads providing a three-dimensional frictional surface, which provides additional stability between the outrigger foot and the staging ground surface. The frictional surface provides the pad with a non-slip feature when the pad is used on slippery surfaces, such as mud, snow and ice. Additionally, the frictional surface of the present outrigger pads provide the pad with interlocking capabilities, either for stacking complimentary outrigger pads on top of one another, or for engagement with another object such as a cribbing block, for changing the height of the outrigger pad.

### TECHNICAL FIELD

The present disclosure relates to outrigger stabilizer pads. More specifically, the present disclosure relates to outrigger stabilizer pads having at least one surface with a frictional element that provides an improved grip and non-slip feature to the pad, particularly when used on slippery surfaces.

### BACKGROUND

It is well known to provide extensible outriggers on vehicles for preventing tipping of the vehicle when the vehicle is in a stationary position. Such extensible outriggers are frequently provided on trucks having upwardly extensible apparatus, such as power company aerial platforms, firefighting equipment including aerial ladders, aerial platforms and aerial water towers. Other vehicles incorporating outriggers include construction cranes and large recreational vehicles. One or more and typically a pair of outriggers are provided on each side of the vehicle, normally-at longitudinally spaced locations. Outriggers are hydraulically-operated sturdy metal legs that extend the footprint of the mobile equipment out to cover a larger area. They can either extend directly from the equipment to the ground at an angle, or extend horizontally outward from the equipment with a vertical leg having a plate-like pad or foot that makes contact with the ground. In either case, the outriggers must lift all the weight of the equipment up off the tires to provide maximum stability. Outriggers are used to effectively widen the area in which the vehicle is supported on the ground, further stabilizing the vehicle to prevent tipping when aerial equipment is in use.

Stability is dependent on the equipment's footprint and center of mass. The footprint is the total area enclosed by the support structures of the equipment. The center of mass is the point at which the equipment would balance if it were set on top of a single point of support. If the center of mass is inside the footprint, the equipment is stable. If the center of mass is off the edge of the footprint, the equipment may topple.

The outrigger or stabilizer pad helps to stabilize the outriggers and prevent the stabilizer arm from breaking the surface it is resting on. Equipment and vehicles can be positioned on any variety of surfaces, depending on the particular situation, including soil, asphalt and concrete, which are all not guaranteed to be level or even surfaces. The pad not only provides a more level, stable surface for the outrigger stabilizer arm and associated equipment, but it also helps to prevent damage to the arm and the surrounding surface because it disperses the weight of the equipment over a certain area. The stabilizer or outrigger pad may also prevent movement of the equipment, and may also prevent tipping or rolling of the vehicle or equipment.

In addition to providing stability to the outriggers, outrigger pads also provide a more level and stable surface. Although it is desirable to position a vehicle on a level, dry surface, circumstances generally do not always permit staging on these ideal ground conditions. Having an uneven surface can jeopardize the overall stability of the vehicle. Therefore, it would be advantageous to have the option to change the height of the outrigger pads through stacking of pads, or attachment of another object, such as a cribbing block, for changing the height of the pad for various applications and/or for leveling an uneven surface.

A need, therefore, exists for improved outrigger stabilizer pads. Specifically, a need exists for improved outrigger stabilizer pads which provide additional frictional stability and enhanced non-slip between the ground and the outrigger foot.

Moreover, a need exists for an improved outrigger stabilizer pad having a frictional surface to provide improved grip and prevent slippage particularly on ice, snow, mud or other potentially slippery surfaces.

A need further exists for improved outrigger stabilizer pads having a surface with a plurality of peaks and valleys in a repetitive pattern providing interlocking capabilities with another similar outrigger pad.

A need also exists for improved outrigger stabilizer pads having a surface with a plurality of teeth in a repetitive pattern providing interlocking capabilities with another similar outrigger pad.

A need further exists for improved outrigger stabilizer pads having a frictional surface capable of interlocking with an item having a similar frictional surface thereby providing options to increase the height or change the leveling capacity of an outrigger pad and particularly useful on uneven staging surfaces, or for stacking for storage.

### SUMMARY

The present disclosure relates to outrigger stabilizer pads, and specifically outrigger stabilizer pads having a frictional surface. The improved outrigger stabilizer pads can be used to improve grip on any surface, particularly on slippery and/or uneven surfaces. Specifically, the surface of the pad comprises a frictional element having a configuration of a plurality of teeth, or peaks and valleys, which give the pad improved gripping capabilities. The frictional surface is also capable of meshing and interlocking with another pad or other object having a complimentary frictional surface structure.

To this end, in an embodiment of the present disclosure, an improved outrigger stabilizer pad is provided. The outrigger stabilizer pad comprises a pad formed from a top wall, a bottom wall, and at least one side wall, a front surface on the top wall, a back surface on the bottom wall, and a frictional element formed on at least one of the front and back surfaces.

In another embodiment of the present disclosure, an improved outrigger pad for use in stabilizing an outrigger foot on a piece of heavy equipment, is provided. The outrigger pad comprises a pad formed from a top wall, a bottom wall, and at least one side wall forming a perimeter of the pad, a front side on the top wall, a back side on the bottom wall, a frictional surface on at least one of the front side or the back side, the frictional surface configured to minimize slip of the pad on a ground surface. The pad further includes at least one opening passing through the front side and the back side.

It is, therefore, an advantage and objective of the present disclosure to provide improved outrigger stabilizer pads having a frictional element that provides stability between the ground and the outrigger foot.

It is yet another advantage and objective of the present disclosure to provide an outrigger stabilizer pad having a frictional surface to provide improved grip and prevent slippage when the pad is positioned on ice, snow, mud or other potentially slippery surfaces.

It is yet another advantage and objective of the present disclosure to provide an outrigger stabilizer pad having a surface capable of interlocking engagement with another similar pad or device having a similar surface, providing customizable height adjustment to the outrigger pad or storage capabilities.

Another advantage and objective of the present disclosure is to provide an outrigger stabilizer pad that provides stability to an outrigger mechanism on uneven surfaces.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of an embodiment of an outrigger stabilizer pad according to the present disclosure;

FIG. 2 illustrates a back view of the embodiment of the outrigger stabilizer pad of FIG. 1;

FIG. 3 illustrates a side view of the embodiment of the outrigger stabilizer pad of FIG. 1;

FIG. 4 illustrates a perspective view of another embodiment of an outrigger stabilizer pad according to the present disclosure; and,

FIG. 5 illustrates a perspective view of the frictional element of the outrigger stabilizer pad of the present disclosure.

### DETAILED DESCRIPTION

The present disclosure relates to outrigger pads, and specifically outrigger stabilizer pads having a frictional surface and improved stability between the outrigger foot of an apparatus, such as heavy construction equipment, and the staging surface. The frictional surface enhances the non-slip ability of the pad on slippery surfaces, such as mud, snow and ice. Additionally, the frictional surface of the present outrigger stabilizer pads provide the pad with interlocking capabilities, either for stacking outrigger pads having the same frictional surface on top of one another, or for engagement with another object such as a cribbing block, which can be used for changing the height of the outrigger pad. The present outrigger stabilizer pads provide a level base on uneven or inconsistent ground surfaces.

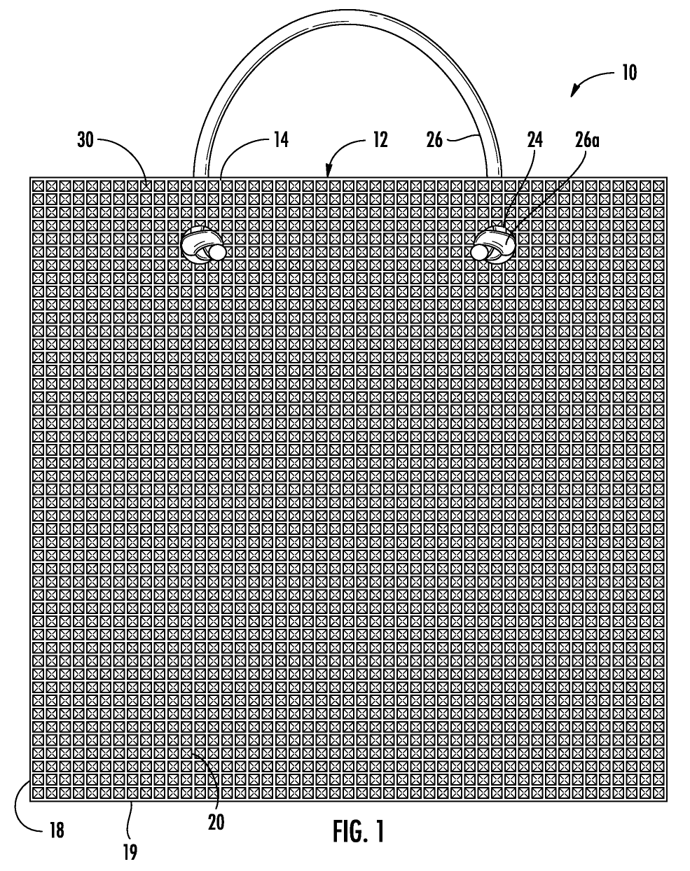

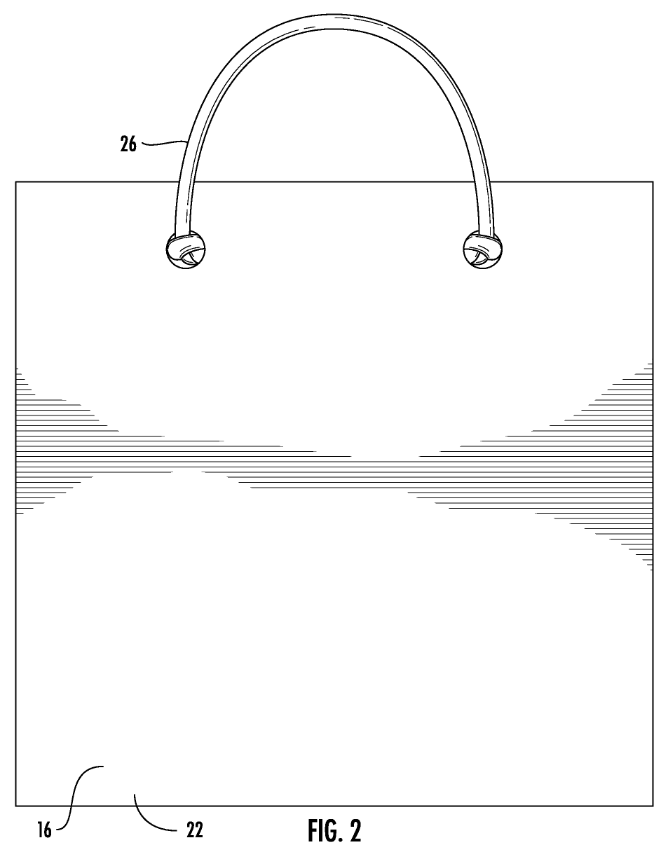

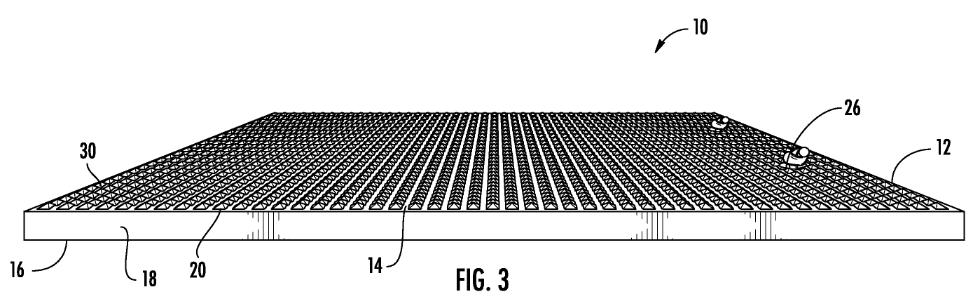

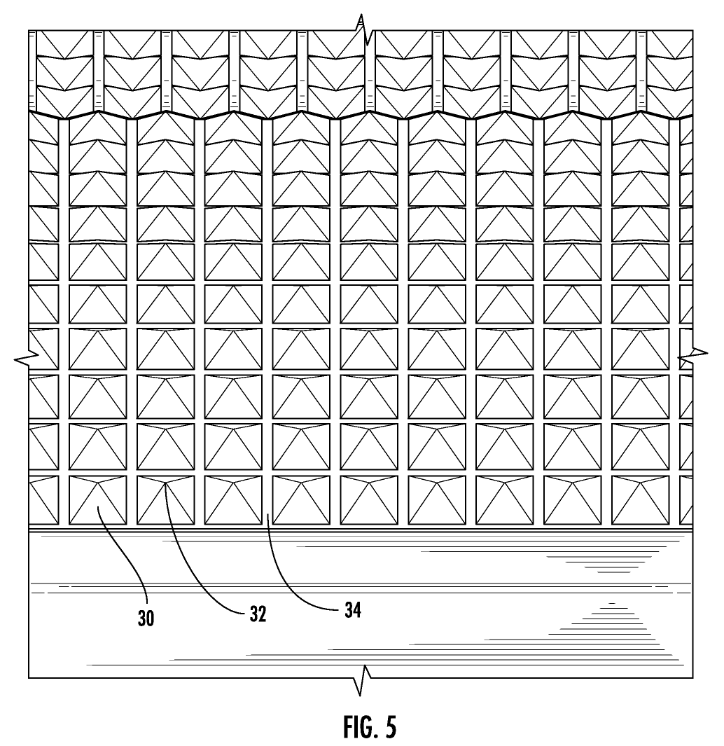

Now referring to the figures, wherein like numerals refer to like parts, FIGS. 1-4 illustrate embodiments of the present outrigger stabilizer pad 10 incorporating the frictional element 30 on a surface of the pad. FIG. 5 illustrates a close-up view of the surface of an embodiment of the present outrigger stabilizer pads, illustrating the details of the frictional element configuration of the surface of the present outrigger stabilizer pad.

Outrigger stabilizer pads can be constructed from any durable material, including wood and plastics, preferably UHWM polyethylene, which can be cut, heat stamped, shaped or molded into any desired form using known techniques. Stabilizer pads of the type described in the present disclosure are generally used to provide a support platform for a typical outrigger on an apparatus, such as heavy construction equipment, including construction cranes, RVs and other large mobile homes, fire engines and apparatus. The present disclosure illustrates both a square pad and a round pad; however, it should be understood that the present outrigger pad can have any variety of geometric shapes.

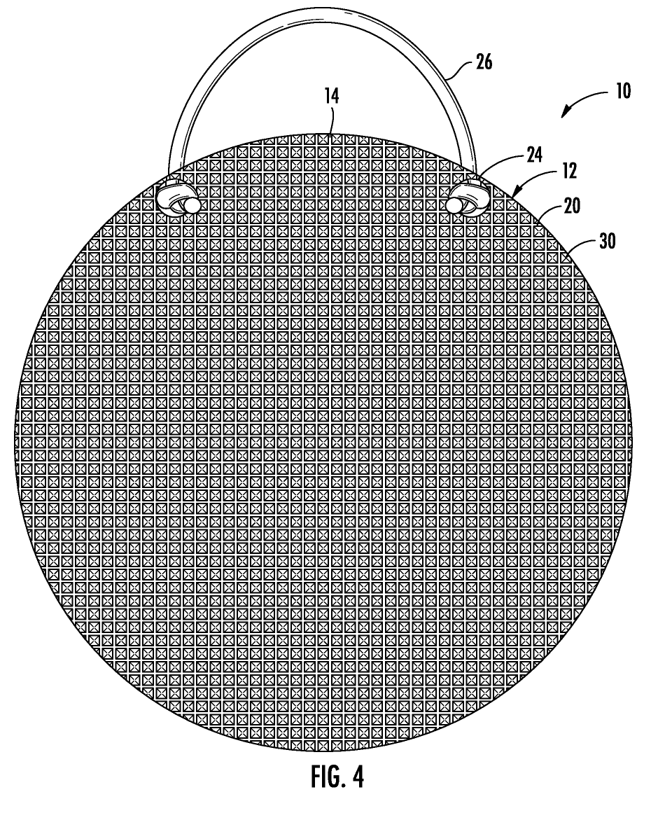

As shown in FIGS. 1-3, the outrigger stabilizer pad 10 of the present embodiment comprises a pad 12 formed from a top wall 14, a bottom wall 16, and a side wall 18, which forms an outer perimeter 19 of the pad. As noted, the pad 10 can have any geometric shape, typically square and round (FIGS. 1 and 4). The top wall 14 includes a front surface or side 20, while the bottom wall 16 has a back surface or side 22. Positioned typically near the perimeter 19 of the pad, there is at least one opening 24 adapted for receiving the end of a handle 26. The opening 24 passes through the front side 20 and the back side 22. Preferably, the pad 10 includes two openings spaced apart from one another across the pad 10 (FIGS. 1 and 4). The openings 24 receive and secure a handle 26, in this case a rope or plastic handle, secured either by tying the distal ends 26a of the handle as a knot within the opening, as shown. Optionally, the handle 26 may be secured to the pad 10 another know securing mechanism or known fastener.

As shown in the Figures, at least one handle 26 is attached to the pad 10. Although a single handle 26 is shown in the Figures, it should be understood that a single pad may include two or more handles positioned at various points around the body of the pad. The handle 26, having a generally C-shape or U-shape, and can be constructed from a variety of durable and flexible materials, for example, rope, plastic and rubber. As shown the Figures, the distal ends 26a of the handle are inserted through the opening 24 in the pad. The handle 26 is ideally shaped to provide enough clearance so that the user can easily slip a hand between the handle and the perimeter 19 of the pad 10 for grasping, carrying and positioning of the pad.

FIGS. 1-4 illustrate square and round embodiments of outrigger stability pads 10 according to the present disclosure. In these particular embodiments, the entire front surface 20 to the perimeter 19 of each pad 10 is covered by the frictional element 30. The frictional element 30 can be described as a plurality of “peaks 32 and valleys 34” or a plurality of “teeth,” which form a repetitive, three dimensional surface over the entirety of the front surface 20 of the pad 10. Optionally, the back surface 22 of the bottom wall 16 can also include the same frictional element 30 across the entirety of the back surface. Although FIGS. 1 and 4 show the entire front surface 20 of the pad 10 covered by or formed as the frictional element 30, it should be understood that the frictional element can cover an area less than the entire front surface 20 of the pad 10, and/or the frictional element may be arranged in any pattern suitable for a specific purpose or as customization surface for a customer.

FIG. 5 illustrates a closer view of the three dimensional configuration of the raised peaks 32 and valleys 34 surface of the frictional element 30. The peaks 32 and valleys 34 of the frictional element 30 on the surface 20 of the pad 10 provide the pad with a raised surface capable of anti-slip properties. In particular, when the pad 10 is placed with the frictional element 30 in contact with the ground, the peaks 32 are capable of gripping or grabbing onto the ground. This is particularly advantageous on slippery surfaces, such as mud, snow or ice. The grip provided by the pad 10 further acts as a brace preventing lateral movement of the pad on the staging ground. The natural valleys 34 provided by the frictional element 30 pattern are further useful for directing moisture or water away from the surface of the pad 10. Additionally, the frictional element 30 pattern may be complimented by additional channels (not shown) disposed on the surface 20 of the pad 10, which are also useful for directing moisture, water or other liquids away from the surface of the pad when placed on the staging ground.

Another feature offered by the present outrigger stabilizer pad 10 is that pads with a similar or complementary three dimensional surface features are capable of being stacked one on top of another in an interlocking manner. This can be particularly useful with uneven staging grounds, where the outriggers of a vehicle may be at different heights. When the present outrigger stabilizer pad 10 is positioned with the frictional element 30 face up, the peaks 32 and valleys 34 surface configuration enables the pad to mesh or interlock with another pad having a complimentary surface configuration. In this manner, the stacked pads are less likely to slip apart from one another. The interlocking feature of the frictional element 30 of the outrigger pads 10 permits pads to be joined together, providing additional height. Other items having a similar frictional element surface, such as a cribbing block (not shown), may engage with the frictional element of the outrigger pad to adjust the height of the pad. Additionally, stacking outrigger pads that may interlock with one another is convenient for storage of the pads.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. An outrigger pad for use between an outrigger foot and a surface, the outrigger pad comprising:
a pad formed from a top wall, a bottom wall, and at least one side wall;
a front surface on the top wall;
a back surface on the bottom wall; and
a frictional element formed on at least one of the front and back surfaces.

2. The outrigger pad of claim 1 wherein the side wall forms a perimeter of the pad.

3. The outrigger pad of claim 1, wherein the frictional element is formed on the front surface of the pad.

4. The outrigger pad of claim 1, wherein the frictional element is formed on the back surface of the pad.

5. The outrigger pad of claim 1, wherein the frictional element is formed on both the front surface and on the back surface of the pad.

6. The outrigger pad of claim 1, wherein the frictional element completely covers the front surface of the pad to the perimeter of the pad.

7. The outrigger pad of claim 1, wherein the frictional element is a plurality of peaks connected with valleys.

8. The outrigger pad of claim 1, wherein the frictional element is a plurality of teeth.

9. The outrigger pad of claim 1, wherein the pad further includes at least one opening.

10. The outrigger pad of claim 9, wherein the opening passes through the top wall and the bottom wall.

11. The outrigger pad of claim 10, wherein the opening is configured for receiving a handle.

12. The outrigger pad of claim 1, wherein the pad further includes at least a pair of openings.

13. The outrigger pad of claim 12, wherein the openings are configured for receiving a handle.

14. An outrigger pad for use in stabilizing an outrigger foot on a piece of heavy equipment, the outrigger pad comprising:
a pad formed from a top wall, a bottom wall, and at least one side wall forming a perimeter of the pad;
a front side on the top wall;
a back side on the bottom wall;
a frictional surface on at least one of the front side or the back side, the frictional surface configured to contact a ground surface and minimize slip of the pad on the ground surface; and,
at least one opening through the front side and the back side.

15. The outrigger pad of claim 14, wherein the frictional surface is distributed uniformly on the front side of the top wall.

16. The outrigger pad of claim 14, wherein the frictional surface is distributed uniformly on the front side and the back side.

17. The outrigger pad of claim 14, wherein the frictional surface comprises a repetitive pattern of peaks and valleys.

18. The outrigger pad of claim 17, wherein the peaks and valleys are configured to engage the ground surface.

19. The outrigger pad of claim 17, wherein the peaks and valleys are configured to engage a corresponding frictional surface on another device.

20. The outrigger pad of claim 14, wherein the opening is configured for receiving a handle.
